(19) United States
(12) Patent Application Publication
(10) Pub. No.: US 2024/0332623 A1
(43) Pub. Date: Oct. 3, 2024

(54) Liquid Electrolyte Composition, and Electrochemical Cell Comprising Said Electrolyte Composition

(71) Applicant: Bayerische Motoren Werke Aktiengesellschaft, Muenchen (DE)

(72) Inventors: Alexander ADAM, Muenchen (DE); Roland JUNG, Muenchen (DE); Juliane KLUGE, Oxford (GB); Peter LAMP, Landsberg am Lech (DE); Arianna MORETTI, Muenchen (DE); Sebastian SCHARNER, Tuerkenfeld (DE); Thomas WOEHRLE, Muenchen (DE)

(21) Appl. No.: 18/580,245

(22) PCT Filed: Jul. 13, 2022
(86) PCT No.: PCT/EP2022/069658

§ 371 Date: Jan. 18, 2024

(30) Foreign Application Priority Data
Jul. 21, 2021 (DE) 10 2021 118 811.3

(51) Int. Cl. H01M 10/0568; H01M 10/0525; H01M 10/0567; H01M 10/0569

(52) U.S. Cl. CPC H01M 10/0568; H01M 10/0525; H01M 10/0567; H01M 10/0569; H01M 2300/002

(57) ABSTRACT

A liquid electrolyte composition for an electrochemical cell is provided. The liquid electrolyte composition includes the following components: (A) sulfur dioxide; (B) at least one salt. The salt containing an anionic complex with at least one bidentate ligand, and the salt corresponds to formula (I) or formula (II).

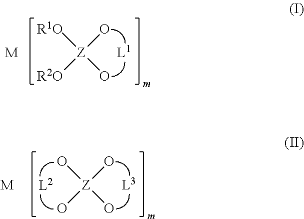

M is a metal cation selected from the group consisting of alkali metals, alkaline earth metals, and metals from group 12 in the periodic table, m represents 1 or 2, Z is a central ion selected from among the group consisting of aluminum and boron. R₁ and R₂ each represents a monovalent hydrocarbon group; L₁, L₂ and L₃ each independently represents an aliphatic or aromatic bridge group, the bridge group along with the central ion Z and with two oxygen atoms bound to the central ion Z and to the bridge group forming a ring.

### CROSS REFERENCE TO RELATED APPLICATION

This application contains subject matter related to U.S. application Ser. No. ______, entitled “Liquid Electrolyte Composition, and Electrochemical Cell Comprising Said Electrolyte Composition,” filed on even date herewith (Attorney Docket No. 080437.PH270US).

### BACKGROUND AND SUMMARY

The present invention relates to an electrolyte composition, and an electrochemical cell comprising the electrolyte composition.

Electrochemical cells are of major importance in many areas of technology. In particular, electrochemical cells are often used for applications in which low voltages are required, such as for the operation of laptops or mobile phones. An advantage of electrochemical cells is that many individual cells can be connected together. For example, cells connected in series can deliver a high voltage, while connecting cells in parallel results in a high nominal capacity. Such interconnections result in higher-energy batteries. Such battery systems are also suitable for high-voltage applications and can, for example, allow vehicles to be driven electrically, or corresponding systems can also be used for stationary energy storage.

In the following, the term “electrochemical cell” is used synonymously for all designations customary in the art for rechargeable galvanic elements, such as cell, battery, battery cell, accumulator, battery accumulator and secondary battery.

An electrochemical cell is able to provide electrons for an external circuit during the discharge process. Conversely, an electrochemical cell can be charged during the charging process by means of an external circuit by supplying electrons.

An electrochemical cell has at least two different electrodes, a positive (cathode) and a negative (anode) electrode. Both electrodes are in contact with an electrolyte composition.

The most commonly used electrochemical cell is the lithium-ion cell, also called a lithium-ion battery.

Lithium-ion cells are known to have a composite anode, which very often comprises a carbon-based anode active material, typically graphitic carbon, which is deposited on a metallic copper carrier foil. The cathode generally comprises metallic aluminum which is coated with an active cathode material, for example a layered oxide. Composite cathodes according to the art are quite often composed of a layer of oxide (for example LiCoO₂ or LiNi_{1/3}Mn_{1/3}Co_{1/3}O₂), which can be coated onto a rolled aluminum carrier foil.

Electrolyte composition plays a key role in the safety and performance of an electrochemical cell. This ensures the charge balance between the cathode and anode during the charging and discharging process. The flow of current required for this is achieved by the ion transport of a conductive salt in the electrolyte composition. In lithium-ion cells, the conductive salt is a lithium conductive salt, and lithium ions serve as the current-carrying ions.

There is therefore a need to select a suitable conductive salt which can be dissolved in the electrolyte composition to a sufficient extent and which also has suitable ion conductivity in order to maintain effective charge equalization during operation. The most common conductive salt in lithium-ion cells is lithium hexafluorophosphate (LiPF₆).

In addition to the lithium conductive salt, electrolyte compositions contain a solvent which enables dissociation of the conductive salt and sufficient mobility of the lithium ions. Liquid organic solvents are known in the art that consist of a variety of linear and cyclic dialkyl carbonates. Mixtures of ethylene carbonate (EC), dimethyl carbonate (DMC), diethyl carbonate (DEC), propylene carbonate (PC), and ethyl methyl carbonate (EMC) are generally used.

It is important to note that each solvent has a specific stability range for the cell voltage, also referred to as the “voltage window.” In this voltage window, the electrochemical cell can run stably during operation. If the cell voltage approaches the upper voltage limit, an electrochemical oxidation of the components of the electrolyte composition takes place. At the lower end of the voltage window, on the other hand, reductive processes take place. Both redox reactions are unwanted, reduce the performance and reliability of the cell, and in the worst case, lead to its failure.

The processes described herein are particularly relevant for the deep discharging and overcharging of a lithium-ion cell.

Lithium-ion cells with the organic electrolyte compositions of the art tend to gas during the charging and discharging processes. “Gassing” is understood to mean an electrochemical decomposition of the components of the electrolyte into volatile and gaseous compounds due to the use of too high a cell voltage. Gassing reduces the proportion of the electrolyte and leads to the formation of unwanted decomposition products, resulting in a shorter service life and lower performance of the lithium-ion cell.

In order for the cell to be able to work in the broadest possible potential range, fluorinated solvents or additives are added to the electrolyte compositions of the art. Fluorinated solvents such as fluoroethylene carbonate (FEC) are chemically inert and electrochemically stable with respect to the operating voltages of the lithium-ion cell.

A common drawback of fluorinated electrolytes is that in the event of a thermal defect in the cell, increased heat release and the formation and emission of harmful gases such as hydrogen fluoride (HF) can occur.

Because of these drawbacks, lithium-ion cells have a large number of regulating and control mechanisms in order to keep the cells in a voltage range that is optimal for the respective solvent during operation and thus stabilize the electrolyte composition.

Various approaches for stable electrolyte compositions are known in the art.

EP 1689756 B1 describes a process for preparing weakly coordinating anions of the formula X(OR^{F})ₘ, in which X is selected from the group consisting of B, Al, Ga, In, P, As and Sb, m is 3 or 5, and R^{F} represents a straight-chain or branched-chain, partially or fully fluorinated alkyl or aryl radical. The weakly coordinating anions form salts with mono- or divalent cations, preferably with alkali metal ions. Because of the chemical stability, in particular of the anion, the salts disclosed were proposed inter alia for use as inert lithium conductive salts in lithium-ion batteries. However, an electrolyte composition with the weakly coordinating anions for use in lithium-ion batteries has not been disclosed.

In addition to selecting a chemically inert conductive salt, the stability of the battery cells can also be increased by selecting a suitable solvent. Electrolyte compositions based on sulfur dioxide have, in particular, increased ionic conductivity and thus allow battery cells to be operated at high discharge currents without adversely affecting the stability of the cells. Furthermore, electrolyte compositions based on sulfur dioxide are characterized by a high energy density, a low self-discharge rate, and limited overcharging and deep discharging.

A drawback of sulfur dioxide is that it only insufficiently dissolves many lithium conductive salts, which are readily soluble in organic solvents. Therefore, for example, the widely used lithium conductive salt lithium hexafluorophosphate cannot be used for electrolyte compositions containing sulfur dioxide.

EP 1201004 B1 discloses a rechargeable electrochemical cell with an electrolyte based on sulfur dioxide. In this case, sulfur dioxide is not added as an additive, but represents the main component of the electrolyte composition. It should therefore at least partially ensure the mobility of the ions of the conductive salt, which bring about the charge transport between the electrodes. In the proposed cells, lithium tetrachloroaluminate is used as a lithium-containing conductive salt in combination with a cathode active material made of a metal oxide, in particular an intercalation compound such as lithium cobalt oxide (LiCoO₂). Functional and rechargeable cells have been obtained by adding a salt additive, for example an alkali metal halide such as lithium fluoride, sodium chloride or lithium chloride, to the electrolyte composition containing sulfur dioxide.

EP 2534719 B1 presents a rechargeable lithium battery cell with an electrolyte based on sulfur dioxide in combination with lithium iron phosphate as a cathode active material. Lithium tetrachloroaluminate was used as the preferred conductive salt in the electrolyte composition. In experiments with cells based on these components, a high electrochemical resistance of the cells could be demonstrated.

WO 2021/019042 A1 describes rechargeable battery cells with an active metal, a layered oxide as a cathode active material and an electrolyte containing sulfur dioxide. Due to the poor solubility of many common lithium conductive salts in sulfur dioxide, a conductive salt of the formula M⁺[Z(OR)₄]⁻ was used in the cells, where M represents a metal selected from the group composed of an alkali metal, alkaline earth metal and a metal of group 12 of the periodic table, and R is a hydrocarbon radical. The alkoxy groups —OR are each monovalently bonded to the central atom, which can be aluminum or boron. In a preferred embodiment, the cells contain a perfluorinated conductive salt of the formula Li⁺[Al(OC(CF₃)₃)₄]⁻. Cells consisting of the described components show a stable electrochemical performance in experimental studies. In addition, the conductive salts, in particular the perfluorinated anion, have surprising hydrolytic stability. Furthermore, the electrolytes should be oxidation-stable up to an upper potential of 5.0 V. It was further shown that cells with the disclosed electrolytes can be discharged or charged at low temperatures of down to −41° C. However, no measurements of electrochemical performance at high temperatures have been carried out.

The thermal stability of perfluorinated lithium aluminates at high temperatures was examined in a scientific study by Malinowski et al. (Dalton Trans., 2020, 49, 7766). In the study, the authors characterized various properties of [Al(OC(CF₃)₃)₄] salts, including the temperature stability of the lithium derivative. Thermogravimetric studies showed that the compound Li[Al(OC(CF₃)₃)₄] already shows a mass loss at 105° C., which is caused by a starting decomposition of the fluorinated anion.

The object of the invention is to provide an electrolyte composition for an electrochemical cell, and in particular rechargeable batteries, that is inexpensive and safe to operate at various working voltages.

The invention achieves this object by means of a liquid electrolyte composition for an electrochemical cell in accordance with embodiments of the independent claim(s).

Advantageous embodiments of the electrolyte composition according to the invention are described in the dependent claims, which can optionally be combined with one another.

### DETAILED DESCRIPTION

According to the invention, the object is achieved by a liquid electrolyte composition for an electrochemical cell. The electrolyte composition includes the following components: (A) sulfur dioxide; (B) at least one salt, wherein the salt includes an anionic complex with at least one bidentate ligand and the salt corresponds to Formula (I) below:

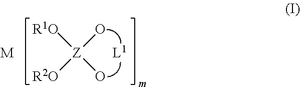

### or Formula (II)

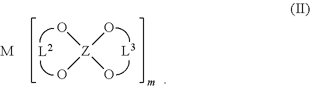

M is a metal cation selected from the group composed of the alkali metals, alkaline earth metals and metals of group 12 in the periodic table. m represents an integer from 1 to 2, and Z denotes a central ion selected from the group composed of aluminum and boron. R₁ and R₂ each represent a monovalent hydrocarbon radical and are independently selected from the groups C₁-C₈ alkyl, C₂-C₁₀ alkenyl, C₂-C₁₀ alkinyl, C₆-C₁₂ cycloalkyl and C₆-C₁₄ aryl. L¹, L² and L³ each independently represent an aliphatic or aromatic bridging group. The bridging group forms a ring with the central ion Z and with two oxygen atoms bonded to the central ion Z and the bridging group, wherein the ring contains a continuous sequence of 2 to 5 carbon atoms.

The salts proposed according to the invention have an ion that comprises at least one bidentate ligand. In the context of the invention, a bidentate ligand is understood to refer to a molecule that comprises at least two oxygen atoms and bonds to a central ion Z via the at least two oxygen atoms. It would also be conceivable to use other multidentate ligands having a different denticity, such as for example tridentate, tetradentate, pentadentate or hexadentate.

Bidentate or multidentate ligands are also generally known as chelate ligands, and the complexes composed of them as chelate complexes. The anion of the salt of Formula (I) and Formula (II) is thus a chelate complex. In the context of this invention, chelate complexes and the salts formed therefrom show various advantages over monovalent complexes and the salts formed therefrom.

Chelate complexes are chemically more stable than their monovalent derivatives. The bonds between the chelate ligand and the central ion are difficult to break, which is why the chelate complexes according to the invention are chemically inert to external chemical and physical influences.

According to the invention, a chelate complex represents the anion of the at least one salt of Formula (I) or (II), the salt serving as the conductive salt of the electrolyte composition. The electrolyte composition thus enables charge balancing between the two electrodes with which it is in contact.

Another advantage is the high affinity of the chelating ligand for the central ion. The chelate complexes used according to the invention are chemically and electrochemically stable compounds which, due to the strongly coordinating properties of the ligand with respect to the central ion, have a low affinity for binding to positively charged ions. The chelate complexes themselves are therefore weakly coordinating anions. Therefore, the conductive salt in the electrolyte composition can dissociate almost completely without reforming back to the starting salt and forms ions with a high mobility and a correspondingly high ionic conductivity in solution. This in turn increases the electrochemical performance of the electrochemical cell.

Because of these properties, the chelate complexes used according to the invention, in particular the salts composed thereof, are resistant to both temperature and hydrolysis.

According to the present invention, the salts described are sufficiently soluble in liquid sulfur dioxide, which is the inorganic solvent of the electrolyte composition. In the context of the invention, sulfur dioxide is not only contained as an additive in low concentrations in the electrolyte composition, but is also present to an extent that it can ensure the mobility of the ions of the conductive salt as a solvent.

Sulfur dioxide is gaseous at room temperature under atmospheric pressure and forms stable liquid solvate complexes with lithium conductive salts, which have a noticeably reduced vapor pressure compared to sulfur dioxide as a pure substance. The gaseous sulfur dioxide is thus bound in liquid form and can be handled safely and comparatively easily. A particular advantage is the non-combustibility of sulfur dioxide itself and of the solvate complexes, which increases the operational safety of the electrolyte compositions based on such solvate complexes and of the cells produced using the electrolyte composition.

The salts described with the chelate complexes of Formulas (I) and (II) are non-flammable. The electrolyte compositions according to the invention are therefore also non-flammable and enable safe operation of an electrochemical cell which comprises the disclosed components of the electrolyte composition. If sulfur dioxide escapes from the cell due to mechanical damage, it cannot ignite outside the cell.

In addition, the electrolyte composition according to the invention is also inexpensive compared to conventional organic electrolytes. The elevated temperature stability and resistance to hydrolysis enable direct and almost complete recycling of the electrolyte composition from old batteries without increased effort. Hydrothermal processes under high pressure and at high temperatures are usually used to recycle old batteries. Conventional electrolyte compositions are usually not resistant to hydrolysis and therefore have to be processed in some other way. For this purpose, the electrolyte compositions are extracted from batteries in a laborious process, for example by rinsing the cells with supercritical carbon dioxide. In contrast, more recent electrolyte formulations based on aluminate, borate or gallate salts, as described in the art, are usually not sufficiently thermally stable.

The electrolyte composition described herein is thermally stable and resistant to hydrolysis and can therefore be recycled directly from the electrochemical cells at low cost using water-based extraction methods. Because of the water solubility of the components, the electrolyte composition described herein has a high recycling potential with a high recycling rate.

Recycling reduces both the primary raw material consumption and the energy demand of the electrolyte composition required for the production of a freshly manufactured electrolyte composition, and thus also the carbon dioxide emission caused during this manufacturing process. Thus, the manufacturing costs of the electrolyte composition according to the invention and the electrochemical cell manufactured using the electrolyte composition can be kept low.

According to the invention, the electrolyte composition includes at least one salt of Formula (I) or (II), wherein the salt includes an anionic complex with at least one bidentate ligand. In the formula, the charge of the anion is stoichiometrically balanced by a positively charged metal cation selected from the group composed of the alkali metals, alkaline earth metals and metals of group 12 in the periodic table. Preferably, the metal cation is a lithium ion and the salt is a lithium salt. m is an integer from 1 to 2, where m is stoichiometrically determined by the oxidation number of the metal cation used.

In Formula (I) or (II), Z denotes a central ion selected from the group composed of aluminum and boron. The salts are thus either aluminates or borates, and accordingly, the anions of Formula (I) or (II) have a single negative charge.

R₁ and R₂ each represent a monovalent hydrocarbon radical and are independently selected from the groups C₁-C₈ alkyl, C₂-C₁₀ alkenyl, C₂-C₁₀ alkinyl, C₆-C₁₂ cycloalkyl and C₆-C₁₄ aryl. In the context of the invention, monovalent means that the hydrocarbon radicals R₁ and R₂ each bond to the central ion Z via a single oxygen atom.

In the context of the invention, the term C₁-C₈ alkyl encompasses linear or branched saturated hydrocarbon radicals having one to eight carbon atoms. Preferred hydrocarbon radicals include, for example, methyl, ethyl, n-propyl, isopropyl, n-butyl, sec-butyl, iso-butyl, tert-butyl, n-pentyl, isopentyl, 2,2-dimethylpropyl, n-hexyl, iso-hexyl, 2-ethylhexyl, n-heptyl, iso-heptyl, n-octyl and iso-octyl.

In the context of the invention, the term C₂-C₁₀ alkenyl encompasses linear or branched, at least partially linear, unsaturated hydrocarbon radicals having two to ten carbon atoms, the hydrocarbon radicals having at least one C═C double bond. Preferred hydrocarbon radicals include, for example, ethenyl, 1-propenyl, 2-propenyl, 1-n-butenyl, 2-n-butenyl, isobutenyl, 1-pentenyl, 1-hexenyl, 1-heptenyl, 1-octenyl, 1-nonenyl and 1-decenyl.

In the context of the invention, the term C₂-C₁₀ alkinyl encompasses linear or branched, at least partially linear, unsaturated hydrocarbon radicals having two to ten carbon atoms, the hydrocarbon radicals having at least one C—C triple bond. Preferred hydrocarbon radicals include, for example, ethinyl, 1-propinyl, 2-propinyl, 1-n-butinyl, 2-n-butinyl, isobutinyl, 1-pentinyl, 1-hexinyl, 1-heptinyl, 1-octinyl, and 1-noninyl 1-decinyl.

In the context of the invention, the term C₆-C₁₂ cycloalkyl encompasses cyclic, saturated hydrocarbon radicals having six to twelve carbon atoms. Preferred hydrocarbon radicals include, for example, cyclopropyl, cyclobutyl, cyclopentyl, cyclohexyl, cycloheptyl, cyclohexyl, cyclononyl and cyclodecanyl.

In the context of the invention, the term C₆-C₁₄ aryl encompasses aromatic hydrocarbon radicals having six to twelve carbon atoms. Preferred hydrocarbon radicals include, for example, phenyl, naphthyl and anthracyl.

In a preferred embodiment, the hydrocarbon radicals R₁ and/or R₂ are at least partially fluorine-substituted.

The bidentate chelate ligand has at least two oxygen atoms and a bridging group L¹, L², or L³ that binds to both oxygen atoms.

L¹, L², or L³ each independently represent an aliphatic or aromatic bridging group.

In an embodiment of the invention, the bridging groups L¹, L² and/or L³ each have a linear, branched or cyclic, saturated, optionally fluorine-substituted hydrocarbon skeleton.

The hydrocarbon skeleton of the bridging groups L¹, L², and/or L³ preferably has 6 to 9 carbon atoms. Hydrocarbon skeletons having a number of carbon atoms in the range mentioned yield anions which form particularly stable salts of Formula (I) or (II).

In a preferred embodiment, the bridging groups L¹, L², and/or L³ each comprise an at least partially fluorine-substituted hydrocarbon skeleton.

The bonding of the bridging groups via the oxygen atoms to the central ion can be interpreted as a coordinate bond for the purposes of the invention. The bonding of the ligand to the central ion forms a ring consisting of a bridging group, the two oxygen atoms bonded to the bridging group and the central ion Z. The ring has at least one continuous sequence of 2 to 5 carbon atoms, preferably 2, 3 or 5 carbon atoms.

Such rings form salts of Formula (III)

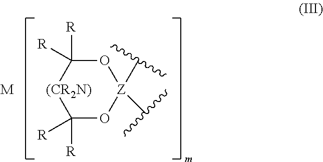

wherein n=0, 1, 2 or 3 and R represents a radical. M is a metal cation selected from the group composed of the alkali metals, alkaline earth metals and metals of group 12 in the periodic table, m is 1 or 2 and Z represents a central ion selected from the group composed of aluminum and boron. The anion of the salt of Formula (III) has either two polycyclic rings according to the bonding situation of Formula (II) or one polycyclic ring and the radicals OR¹ and OR² according to the bonding situation of Formula (I).

The radicals R can be identical or different and independently selected from the group composed of C₁-C₄ alkyl, hydrogen and fluorine.

In the context of the invention, the term C₁-C₄ alkyl includes linear or branched saturated hydrocarbon radicals having one to four carbon atoms. Preferred hydrocarbon radicals include, for example, methyl, ethyl, n-propyl, isopropyl, n-butyl, sec-butyl, iso-butyl and tert-butyl.

In a further embodiment, the hydrocarbon radicals R can be at least partially fluorinated. Preferred fluorinated hydrocarbon radicals include, for example, trifluoromethyl or pentafluoroethyl.

When n in Formula (III) is 0, the ring formed with the central ion Z, the bridging group and the two oxygen atoms bonded to the bridging group is pentacyclic and has a continuous sequence of 2 carbon atoms.

When n in Formula (III) is 1, the ring formed with the central ion Z, the bridging group, and the two oxygen atoms bonded to the bridging group is hexacyclic and has a continuous sequence of 3 carbon atoms.

When n in Formula (III) is 3, the ring formed with the central ion Z, the bridging group and the two oxygen atoms bonded to the bridging group is eight-membered and has a continuous sequence of 5 carbon atoms.

In an embodiment, in Formula (III), n is 0 and the R groups are the same and optionally correspond to fluorine-substituted methyl groups. Such chelate ligands are derived from pinacol as the simplest representative.

In an advantageous embodiment of the invention, component (B) of the electrolyte composition comprises at least one lithium salt of Formula (II). Lithium salts are particularly suitable for use as lithium conductive salts in lithium-ion batteries.

The lithium salt can preferably be selected from the group consisting of lithium bis-(1,1,1,4,4,4-hexafluoro-2,3-bis-(trifluoromethyl)-2,3-butandiolate)-borate with the molecular formula Li[B(O₂C₂(CF₃)₄)₂], abbreviated here as lithium bis(perfluorpinacolato)borate (LiBPFPB), Formula (IV)

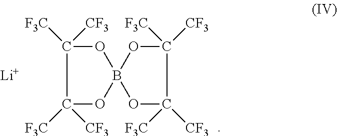

lithium bis-(1,1,1,3,3,5,5,5-octafluoro-2,4-bis-trifluoromethylpentane-2,4-diolate) aluminate having the molecular formula Li[Al(O₂C₂(CF₃)₄CF₂)₂], abbreviated here as LiOTA of Formula (V)

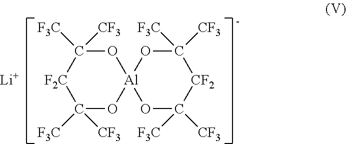

and lithium bis-(1,1,1,5,5,5-hexafluoro-2,3,3,4-tetrakis-trifluoromethylpentane-2,4-diolate)aluminate having the molecular formula Li[Al(O₂C₃(CF₃)₆)₂], abbreviated here as LiHTTDA of Formula (VI)

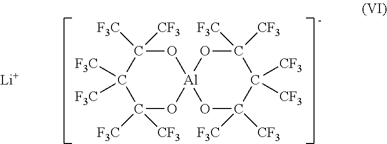

as well as combinations thereof.

The lithium salts LiBPFPB (IV), LiOTA (V), and LiHTTDA (VI) can be prepared according to Examples 1, 2 and 3 described below.

The lithium salts described herein dissolve well in liquid sulfur dioxide as a solvent. The electrolyte compositions produced therefrom are non-flammable and have extremely good ionic conductivity over a wide temperature range.

The conductivity of the lithium salts can be determined by conductive measurement methods. For this purpose, different concentrations of the lithium salts (IV)-(VI) are prepared in sulfur dioxide. The conductivities of the solutions are then determined using a two-electrode sensor immersed in the solution at constant room temperature. For this purpose, the conductivity of the solution with the lithium salts (IV)-(VI) is measured in a range of 0-100 mS/cm.

Due to the high electrochemical stability of the lithium salts, they do not participate in cyclic and calendric aging processes in the battery cell.

Furthermore, the lithium salts described herein have an increased thermal, chemical and electrochemical stability and a particularly pronounced resistance to hydrolysis. Thermal stability can be examined, for example, by means of thermogravimetric analysis (TGA) and differential scanning calorimetry (DSC).

Due to the increased thermal, chemical and electrochemical stability of the conductive salts, the service life of lithium-ion batteries is increased. The electrolyte compositions made from the lithium salts are also less expensive to operate.

In addition, the properties of the lithium conductive salts mentioned enable the selection of a suitable recycling process. A recycling process based on water as a solvent can preferably be used. The lithium conductive salts can thus be completely recovered from the used batteries.

The improved recyclability of the electrolyte saves costs in the battery manufacturing process, which can be offset against the manufacturing costs of the electrolyte salts.

In another embodiment, the electrolyte composition contains component (B) in a concentration of 0.01 to 15 mol/L, preferably 0.1 to 10 mol/L, particularly preferably 0.5 to 5 mol/L, based on the total volume of the electrolyte composition.

The electrolyte composition may further include at least one other additive in a proportion of 0-10 wt. %, preferably 0.1-2 wt. %, based on the total weight of the electrolyte composition.

In an embodiment, the other additives include compounds selected from the group composed of 2-vinylpyridine, 4-vinylpyridine, cyclic exomethylene carbonates, sulfones, cyclic and acyclic sulfonates, acyclic sulfites, cyclic and acyclic sulfinates, organic esters of inorganic acids, acyclic and cyclic alkanes, aromatic compounds, halogenated cyclic and acyclic sulfonylimides, halogenated cyclic and acyclic phosphate esters, halogenated cyclic and acyclic phosphines, halogenated cyclic and acyclic phosphites, halogenated cyclic and acyclic phosphazenes, halogenated cyclic and acyclic silylamines, halogenated cyclic and acyclic halogenated esters, halogenated cyclic and acyclic amides, halogenated cyclic and acyclic anhydrides, and halogenated organic heterocycles.

The other additives contribute to the stability of the electrolyte composition during operation in an electrochemical cell.

The further additives can also make at least one further lithium-containing conductive salt available to the electrolyte composition. In an embodiment, the further lithium-containing conductive salt can contribute to adapting the conductivity of the electrolyte composition to the requirements of the respective cell or to increasing the corrosion resistance of the cathodic metal carrier foil.

Preferred lithium-comprising conductive salts include lithium tetrafluoroborate (LiBF₄), lithium trifluoromethanesulfonate, lithium fluoride, lithium bromide, lithium sulfate, lithium oxalate, lithium (bisoxalato)borate, lithium difluoro(oxalato)borate, lithium tetrahaloaluminate, lithium hexafluorophosphate, lithium bis(trifluoromethanesulfonyl)imide (LiTFSI), and lithium bis(fluorosulfonyl)imide (LiFSI).

Likewise, the other additives can also include other solvents. Other solvents can contribute to adjusting the solubility of the electrolyte composition with respect to polar or non-polar components therein.

The other solvents preferably include vinyl ethylene carbonate (VEC), ethyl methyl carbonate (EMC), vinylene carbonate (VC) and 4-fluoro-1,3-dioxolan-2-one (FEC).

In another embodiment, the further additives can also include at least one solid inorganic lithium ion conductor (solid electrolyte). Suitable examples of solid inorganic lithium ion conductors include perovskites, garnets, sulfides, and amorphous compounds such as glasses, and combinations thereof.

In a particularly preferred embodiment, the electrolyte composition includes the following components: (A) sulfur dioxide; (B) at least one salt of Formula (I) or Formula (II) above in a concentration of 0.01-15 mol/L, preferably 0.1-10 mol/L, based on the total volume of the electrolyte composition, the salt preferably being a lithium salt, particularly preferably selected from the group composed of the compounds of Formulas (IV), (V), and (VI), and combinations thereof, (C) 0-10 wt. %, preferably 0.1-2 wt. %, of at least one additive, the additive preferably being selected from the group composed of vinylene carbonate (VC), 4-fluoro-1,3-dioxolan-2-one (FEC), lithium hexafluorophosphate, cis-4,5-difluoro-1,3-dioxolan-2-one (cDFEC), 4-(trifluoromethyl)-1,3-dioxolan-2-one, bis-(trifluoromethanesulfonyl)imide (LiTFSI) and bis(fluorosulfonyl)imide (LiFSI), and combinations thereof, based on the total weight of the electrolyte composition.

Furthermore, the invention relates to an electrochemical cell with a cathode, an anode and the described electrolyte composition, which is in contact with the cathode and the anode.

In an advantageous embodiment of the invention, the electrochemical cell is a lithium-ion cell, wherein the electrolyte composition comprises the following components: (A) sulfur dioxide; (B) 0.5-2 mol/L of a salt of Formula (V) based on the total volume of the electrolyte composition; (C) 0.1-2 wt. % of lithium hexafluorophosphate and 0.1-2 wt. % of 4-fluoro-1,3-dioxolan-2-one (FEC), based respectively on the total weight of the electrolyte composition.

The lithium-ion cells described herein are inexpensive and can be safely operated at different working voltages. The associated electrochemical properties can be determined by measurements on test cells.

The cyclic aging resistance of the test cells can be determined via the number of cycles. The test cells are initially charged with a constant charging current up to a maximum permissible cell voltage. The upper cutoff voltage is kept constant until a charging current has fallen to a specified value or the maximum charging time has been reached. This is also known as I/U loading. The test cells are then discharged with a constant discharge current intensity up to a given cutoff voltage. Depending on the desired number of cycles, charging can be repeated. The upper cutoff voltage and the lower cutoff voltage, as well as the given charging or discharging current strengths, must be chosen experimentally. This also applies to the value to which the charging current has dropped.

The calendric aging resistance and the extent of self-discharge can be determined by storing a fully charged battery cell, in particular at elevated temperature. To do this, the battery cell is charged up to the permissible upper voltage limit and maintained at this voltage until the charging current has dropped to a previously specified limit value. The cell is then disconnected from the power supply and stored in a temperature chamber at an elevated temperature, for example at 45° C., for a specific time, for example one month (Variant 1). The cell is then removed from the temperature chamber and the remaining capacity is determined under defined conditions. For this purpose, a discharge current is selected which, for example, numerically corresponds to one third of the nominal capacity, and the cell is thus discharged down to the lower discharge limit. This process can be repeated any number of times, for example until the detectable residual capacity has dropped to a predetermined value, for example 70% of the rated capacity. In a second variant of the storage (Variant 2), the storage takes place in a temperature chamber with the power supply connected, the voltage corresponding to the upper voltage limit and this voltage being maintained. Tests are carried out according to the two storage variants. The actual calendric aging and the self-discharge of the battery cell is then determined from these tests: the calendric aging corresponds to the capacity loss due to storage according to Variant 2 and is calculated by subtracting the determined residual capacity 2 from the nominal capacity. The self-discharge rate is determined from the difference between the residual capacities 1 and 2 determined by storage according to Variants 1 and 2 in relation to the nominal capacity of the battery cell.

The cathode of the lithium-ion cell preferably comprises a cathode active material.

Preferred cathode active materials for the electrochemical cell include lithium cobalt oxide (LCO), lithium nickel oxide (LNO), lithium nickel cobalt alumina (NCA), lithium nickel manganese cobalt oxide (NMC), lithium manganese oxide (LMO), lithium iron phosphate (LFP), lithium nickel manganese oxide (LMR), lithium nickel manganese oxide spinel (LNMO) and combinations thereof.

Lithium-nickel-manganese-cobalt compounds are also known under the abbreviation NMC, occasionally also under the technical abbreviation NCM. NMC-based cathode materials are used in particular in lithium-ion batteries for vehicles. NMC as a cathode material has an advantageous combination of desirable properties, for example a high specific capacity, a reduced cobalt content, high current capability and high intrinsic safety, which is reflected, for example, in sufficient stability in the event of overcharging.

NMC can be described with the general formula unit Li_{α}NiₓMn_{y}Co_{z}O₂, with x+y+z=1, where a denotes the specification of the stoichiometric proportion of lithium and is usually between 0.8 and 1.15. Certain stoichiometries are given in the literature as triples of numbers, for example NMC 811, NMC 622, NMC 532 and NMC 111. The triple number indicates the relative nickel:manganese:cobalt content. In other words, for example, NMC 811 is a cathode material, with the general formula unit LiNi_{0.8}Mn_{0.1}Co_{0.1}O₂, with α=1. Furthermore, the so-called lithium and manganese-rich NMCs having the general formula unit Li_{1+ε}(NiₓMn_{y}Co_{z})_{1-ε}O₂ can also be used, where F is in particular between 0.1 and 0.6, preferably between 0.2 and 0.4. These lithium-rich layered oxides are also known as over lithiated (layered) oxides (OLO).

In addition to the cathode active material, the cathode can have other components and additives, such as a foil carrier (rolled metal foil) or a metal-coated polymer foil, an electrode binder and/or an electrical conductivity improver, for example conductive carbon black. All customary compounds and materials known in the art can be used as further components and additives.

The anode of the lithium-ion cell preferably comprises an anode active material.

In particular, the anode active material can be selected from the group composed of carbonaceous materials, soft carbon, hard carbon, natural graphite, synthetic graphite, silicon, silicon suboxide, silicon alloys, lithium, lithium alloys, aluminum alloys, indium, indium alloys, tin, tin alloys, cobalt alloys, niobium pentoxide, titanium dioxide, titanates, for example lithium titanates (Li₄Ti₅O₁₂ or Li₂Ti₃O₇), tin dioxide and mixtures thereof.

The anode active material is preferably selected from the group composed of synthetic graphite, natural graphite, graphene, mesocarbon, doped carbon, hard carbon, soft carbon, fullerene, silicon-carbon composite, silicon, surface-coated silicon, silicon suboxide, silicon alloys, lithium, aluminum alloys, indium alloys, tin alloys, cobalt alloys and mixtures thereof.

In addition to the anode active material, the anode can have other components and additives, such as a film carrier, an electrode binder and/or an electrical conductivity improver, for example conductive carbon black, conductive graphite, so-called “carbon nanotubes” (CNT), carbon fibers and/or graphene. All customary compounds and materials known in the art can be used as further components and additives.

### EXAMPLES

### Example 1: Production of LiOTA

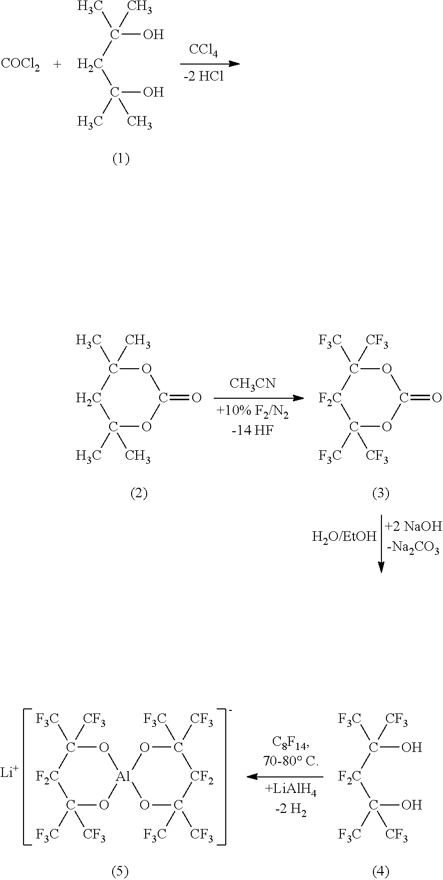

2,4-dimethylpentane-2,4-diol (1) is dissolved in carbon tetrachloride and reacted with phosgene (COCl₂) to give the corresponding 4,4,6,6-tetramethyl-1,3-dioxolane-2-dione (2). The obtained carbonate compound (2) is purified by fractional crystallization in diethyl ether and dried under a vacuum. In the next step, the dried carbonate compound (2) is dissolved in dry acetonitrile. A gas stream is passed through the resulting solution, the gas stream consisting of a fluorine:nitrogen mixture (10% by volume: 90% by volume). This converts the 4,4,6,6-tetramethyl-1,3-dioxolane-2-dione (2) to a perfluorinated carbonate compound (3) which can be isolated by drying under a vacuum. The perfluorinated carbonate is then treated with sodium hydroxide in aqueous alcoholic solution (H₂O/EtOH=1:1; vol./vol. %/o) to give 1,1,1,5,5,5-hexafluoro-2,3,3,4-tetrakis-trifluoromethylpentane-2,4-diol (4). The aqueous solution is then covered with a layer of diethyl ether and the diol (4) is transferred from the aqueous solution into the layered diethyl ether phase by acidification with hydrochloric acid. The diol (4) is purified by repeated crystallization with an aqueous alcoholic solution (H₂O/EtOH=1:1; vol./vol. %). In the final step, the diol (4) is converted with aluminum hydride (LiAlH₄) in perfluorohexane (C₆F₁₄) at 70-80° C. to lithium bis-[1,1,1,3,3,5,5,5-octafluoro-2,4-bis-trifluoromethylpentane-2,4-diolato]aluminate (LiOTA) (5).

### Example 2: Production of LiHTTDA

The salt lithium bis-(1,1,1,5,5,5-hexafluoro-2,3,3,4-tetrakis-trifluoromethylpentane-2,4-diolato) aluminate (LiHTTDA) can be represented according to the synthesis instructions of Example 1. 2,3,3,4-Tetramethylpentane-2,4-diol is used as the starting material.

### Example 3: Preparation of Lithium Bis(Perfluoropinacolato)Borate

Lithium bis(perfluoropinacolato)borate can be synthesized according to the synthesis instructions of Wu Xu and C. Austen Angell (2000 Electrochem. Solid-State Lett. 3, 366).

Hexafluoro-2,3-bis(trifluoromethyl)-2,3-butanediol, lithium hydroxide dihydrate and boric acid are dissolved stoichiometrically in distilled water. The resulting solution is refluxed overnight. The solution is then cooled to room temperature and the remaining water is removed under a vacuum. The obtained reaction product hexafluoro-2,3-bis-(trifluoromethyl)-2,3-butanediol is dried in a drying oven at 100° C. for 48 h. The reaction product is purified by vacuum sublimation at 130° C. with the formation of colorless crystals.

1.-10. (canceled)

11. A liquid electrolyte composition for an electrochemical cell, comprising the following components:
(A) sulfur dioxide; and
(B) at least one salt, wherein the salt comprises an anionic complex having at least one bidentate ligand, the salt corresponds to Formula (I) 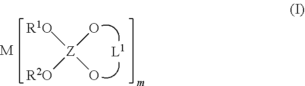
or Formula (II), 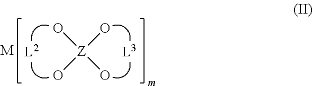
wherein
M is a metal cation selected from the group consisting of alkali metals, alkaline earth metals and metals of group 12 of the periodic table;
m is 1 or 2;
Z is a central ion selected from the group consisting of aluminum and boron;
R₁ and R₂ each represent a monovalent hydrocarbon radical and are independently selected from the group consisting of C₁-C₈ alkyl, C₂-C₁₀ alkenyl, C₂-C₁₀ alkinyl, C₆-C₁₂ cycloalkyl and C₆-C₁₂ aryl;
L¹, L² and L³ each independently represent an aliphatic or aromatic bridging group, wherein the bridging group forms a ring with the central ion Z and forms a ring with two oxygen atoms bonded to the central ion Z and the bridging group, and wherein the ring comprises a continuous sequence of 2 to 5 carbon atoms.

12. The liquid electrolyte composition according to claim 11,
wherein L¹, L² and/or L³ each independently comprise a linear, branched or cyclic, saturated, hydrocarbon skeleton, and
wherein the hydrocarbon skeleton comprises 6 to 9 carbon atoms.

13. The liquid electrolyte composition according to claim 12, wherein L¹, L² and/or L³ each independently comprise a fluorine-substituted hydrocarbon skeleton.

14. The liquid electrolyte composition according to claim 12, wherein the hydrocarbon skeleton is at least partly fluorine-substituted.

15. The liquid electrolyte composition according to claim 11, wherein the continuous sequence of the ring comprises 2 to 3 carbon atoms.

16. The liquid electrolyte composition according to claim 11, wherein the hydrocarbon radicals R₁ and/or R₂ are at least partially fluorine-substituted.

17. The liquid electrolyte composition according to claim 11,
wherein the component (B) of the liquid electrolyte composition comprises at least one lithium salt of Formula (II), and
wherein the lithium salt is selected from the group consisting of B(O₂C₂(CF₃)₄)₂ (LiBPFPB) of Formula (IV), 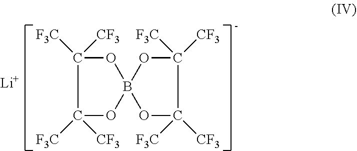
Al(O₂C₂(CF₃)₄CF₂)₂ (LiOTA) of Formula (V), 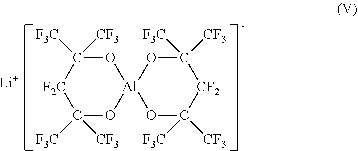
Al(O₂C₃(CF₃)₆)₂ (LiHTTDA) of Formula (VI), 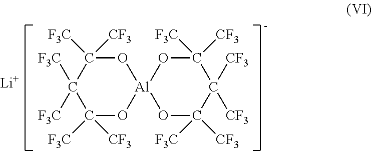
and combinations thereof.

18. The liquid electrolyte composition according to claim 11, wherein the liquid electrolyte composition comprises the component (B) in a concentration of 0.01 to 15 mol/L, based on the total volume of the liquid electrolyte composition.

19. The liquid electrolyte composition according to claim 11, wherein the liquid electrolyte composition comprises the component (B) in a concentration of 0.1 to 10 mol/L, based on the total volume of the liquid electrolyte composition.

20. The liquid electrolyte composition according to claim 11, wherein the liquid electrolyte composition comprises the component (B) in a concentration of 0.5 to 5 mol/L, based on the total volume of the liquid electrolyte composition.

21. The liquid electrolyte composition according to claim 11,
wherein the liquid electrolyte composition comprises at least one further additive in an amount of 0-10 wt. %, based on the total weight of the liquid electrolyte composition, and
wherein the further additive is selected from the group consisting of vinylene carbonate (VC), 4-fluoro-1,3-dioxolan-2-one (FEC), lithium hexafluorophosphate, cis-4,5-difluoro-1,3-dioxolan-2-one (cDFEC), 4-(trifluoromethyl)-1,3-dioxolan-2-one, bis-(trifluoromethanesulfonyl)imide (LiTFSI), bis-(fluorosulfonyl)imide (LiFSI), and combinations thereof.

22. The liquid electrolyte composition according to claim 11,
wherein the liquid electrolyte composition comprises at least one further additive in an amount of 0.1-2 wt. %, based on the total weight of the liquid electrolyte composition,
wherein the further additive is selected from the group consisting of vinylene carbonate (VC), 4-fluoro-1,3-dioxolan-2-one (FEC), lithium hexafluorophosphate, cis-4,5-difluoro-1,3-dioxolan-2-one (cDFEC), 4-(trifluoromethyl)-1,3-dioxolan-2-one, bis-(trifluoromethanesulfonyl)imide (LiTFSI), bis-(fluorosulfonyl)imide (LiFSI), and combinations thereof.

23. The liquid electrolyte composition according to claim 11, comprises the following:
at least one salt of Formula (I) or Formula (II) in a concentration of 0.01-15 mol/L, based on the total volume of the liquid electrolyte composition, wherein the salt is a lithium salt selected from the group consisting of the compounds of Formulas (IV), (V), (VI), and combinations thereof;
0-10 wt. % of at least one additive, wherein the additive is selected from the group consisting of vinylene carbonate (VC), 4-fluoro-1,3-dioxolan-2-one (FEC), lithium hexafluorophosphate, cis-4,5-difluoro-1,3-dioxolan-2-one (cDFEC), 4-(trifluoromethyl)-1,3-dioxolan-2-one, bis-(trifluoromethanesulfonyl)imide (LiTFSI), bis-(fluorosulfonyl)imide (LiFSI), and combinations thereof, based on the total weight of the liquid electrolyte composition.

24. The liquid electrolyte composition according to claim 11, comprises the following:
at least one salt of Formula (I) or Formula (II) in a concentration of 0.1-10 mol/L, based on the total volume of the liquid electrolyte composition, wherein the salt is a lithium salt selected from the group consisting of the compounds of Formulas (IV), (V), (VI), and combinations thereof;
0.1-2 wt. %, of at least one additive, wherein the additive is selected from the group consisting of vinylene carbonate (VC), 4-fluoro-1,3-dioxolan-2-one (FEC), lithium hexafluorophosphate, cis-4,5-difluoro-1,3-dioxolan-2-one (cDFEC), 4-(trifluoromethyl)-1,3-dioxolan-2-one, bis-(trifluoromethanesulfonyl)imide (LiTFSI), bis-(fluorosulfonyl)imide (LiFSI), and combinations thereof, based on the total weight of the liquid electrolyte composition.

25. An electrochemical cell comprising a cathode, an anode, and a liquid electrolyte composition, which is in contact with the cathode and the anode,
wherein the liquid electrolyte composition comprises the following components:
(A) sulfur dioxide; and
(B) at least one salt, wherein the salt comprises an anionic complex having at least one bidentate ligand, the salt corresponds to Formula (I) 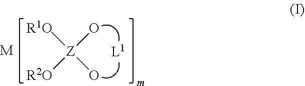
or Formula (II), 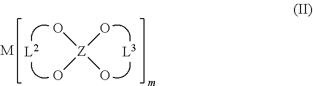
wherein
M is a metal cation selected from the group consisting of alkali metals, alkaline earth metals and metals of group 12 of the periodic table;
m is 1 or 2;
Z is a central ion selected from the group consisting of aluminum and boron;
R₁ and R₂ each represent a monovalent hydrocarbon radical and are independently selected from the group consisting of C₁-C₈ alkyl, C₂-C₁₀ alkenyl, C₂-C₁₀ alkinyl, C₆-C₁₂ cycloalkyl and C₆-C₁₂ aryl;
L¹, L² and L³ each independently represent an aliphatic or aromatic bridging group, wherein the bridging group forms a ring with the central ion Z and forms a ring with two oxygen atoms bonded to the central ion Z and the bridging group, and wherein the ring comprises a continuous sequence of 2 to 5 carbon atoms.

26. The electrochemical cell according to claim 25, wherein the electrochemical cell is a lithium-ion cell, and wherein the liquid electrolyte composition comprises:
0.5-2 mol/L of a salt of Formula (V) based on the total volume of the liquid electrolyte composition; and
0.1-2 wt. % of lithium hexafluorophosphate and 0.1-2 wt. % of 4-fluoro-1,3-dioxolan-2-one (FEC), based respectively on the total weight of the liquid electrolyte composition.
